(19) United States
(12) Patent Application Publication
(10) Pub. No.: US 2019/0375192 A1
(43) Pub. Date: Dec. 12, 2019

(54) MOTOR AND UTILITY VEHICLE SUPPORTING DEVICE

(71) Applicants: LOHMANN GMBH & CO. KG, Neuwied (DE); LOGIS AG, Heldenstein (DE); LOGIS INNOVATIONS GMBH, Heldenstein (DE); LOGIS TECHNOLOGIES GMBH, Heldenstein (DE)

(72) Inventors: Thomas FOGEL, Neuwied (DE); Christoph FRIEB, Heldenstein (DE); Martin HAAG, München (DE)

(73) Assignees: Lohmann GmbH & Co. KG, Neuwied (DE); Logis AG, Heldenstein (DE); Logis Innovations GmbH, Heldenstein (DE); Logis Technologies GmbH, Heldenstein (DE)

(21) Appl. No.: 16/478,401

(22) PCT Filed: Jan. 16, 2018
(86) PCT No.: PCT/EP2018/051002

§ 371 Date: Jul. 16, 2019

(30) Foreign Application Priority Data
Jan. 16, 2017 (DE) 10 2017 100 756.3

(51) Int. Cl. B32B 15/04; B32B 15/20

(52) U.S. Cl. CPC B32B 15/046; B32B 3/30; B32B 15/20

(57) ABSTRACT

Described is a motor and utility vehicle supporting device for a tail lift, a side wall, an access ramp, and/or the bed of a motor and utility vehicle, comprising: a support layer having a first surface and a second surface. The support layer comprises a lightweight board, a top coating placed on the first surface, said top coating comprising polyurethane, polyurea and/or epoxy resin, and an adhesive fixing element which is arranged on the second surface.

### TECHNICAL FIELD

The invention relates to a motor and utility vehicle supporting device for a tail lift, a side wall, an access ramp, and/or the backboard of a motor and utility vehicle.

### PRIOR ART

Motor and utility vehicle supporting devices for tail lifts, side walls, access ramps and/or the backboard of motor and utility vehicles have been known in the art for a long time, also the use of lightweight boards has long since been known in the art. EP 2 392 453 A1 and similarly EP 2 116 449 A1 describe a board of a superstructure of a utility vehicle consisting in two cover layers and a core layer arranged between the two cover layers, wherein at least one of the two cover layers is formed of sheet metal and the core layer is formed of foam plastics. EP 2 116 459 B1 claims a method for producing a floor element for example for a lorry including an upper cover layer composed of an external metal cover layer and an internal support layer as well as a lower cover layer as an endpiece of the floor element facing the vehicle, whereas for stabilising the construction, spaced cross braces are glued together that divide the space between the cover layers into chambers.

Composite boards are also known from EP 0 616 985 B1. Such composite boards include two cover layers made of metal and/or plastics with a core arranged between these layers, which in that case includes a mixture of a filling material with aluminium hydroxide and an organic binding agent based on polymers. DE 196 03 781 A1 shows a loading bed for vehicles such as tippers. The walls and floors are covered with noise-insulating mats or boards. DE 103 11 939 A1 describes a floor construction for the loading bed of a vehicle including a cover and/or a floor plate, wherein the floor construction consists in a cured cell system made of plastic, wherein the cells are separated by partition walls. DE 40 40 284 A1 shows the design of surface elements for a platform superstructure of lorries. The surface elements consist in an outer metal sheet, an inner metal sheet, a glass fibre mat abutting at least one of the metal sheets on the inside and adhesively joined thereto, a honeycomb mat filling the remaining space and a hard foam filling the cells of the honeycomb mat.

The motor and utility vehicle supporting devices usually are suited only for particular fields of use. For installing and functionalising the motor and utility vehicle supporting devices, additional products and materials as well as additional work steps are required. This has a negative effect on retrofitting or exchanging motor and utility vehicle supporting devices. The number of work steps required and the additional products required are associated with comparatively long downtimes and purchasing costs.

Moreover, many of the known motor and utility vehicle supporting devices are characterised by a comparatively short life as their surfaces are exposed to forces very frequently and without protection.

### ILLUSTRATION OF THE INVENTION

Based on the prior art, it is one object of the present invention to provide an improved motor and utility vehicle supporting device.

This objective is solved by a device with the features of claim 1. Advantageous embodiments derive from the dependent claims.

Accordingly, the invention relates to a motor and utility vehicle supporting device for a tail lift, a side wall, an access ramp, and/or the backboard of a motor and utility vehicle. According to the invention, the motor and utility vehicle supporting device comprises a support layer having a first surface and a second surface, wherein the support layer comprises a lightweight board, a cover coating arranged on the first surface, whereas the cover coating comprises a polyurethane, polyurea and or/epoxy resin and an adhesive fastening arranged on the second surface.

The combination of support layer, cover coating and adhesive fastening forms a finished product that significantly reduces the number of work steps at the installation site. This eliminates time-consuming coating processes at the installation site like additional spraying procedures, for example. In particular, it is no longer necessary to elaborately prepare the installation site for the coating step. The motor and utility vehicle supporting device can be glued in as it is without the need for an additional adhesive system to be applied. Overall, the motor and utility vehicle supporting device described above facilitates and accelerates assembly.

Moreover, a resilient motor and utility vehicle supporting device can be provided at comparatively low weight. The components of the motor and utility vehicle supporting device can be coordinated such that the individual layers do not come apart even when subjected to high mechanical loads or in the event of large temperature variations. The support layer gives the motor and utility vehicle supporting device sufficient strength and rigidity at comparatively low weight. By coating the support layer with a plastic on one side and an adhesive on the other, bonding strength is achieved that is guaranteed also in the event of severe deformation of the device.

The plastic used for the cover coating can be adapted to the desired field of use through appropriate selection or modification. This results in a universal field of use for the motor and utility vehicle supporting device. For example, the motor and utility vehicle supporting device can be used for achieving an anti-slip effect. It can be installed on floor and wall areas of a transport surface of a motor or utility vehicle to help securing the load. Alternatively, the motor and utility vehicle supporting device can also exhibit slide-enhancing properties. Such a motor and utility vehicle supporting device can be used in areas of a motor and utility vehicle where the load is supposed to be able to glide at minimum resistance in relation to the surface of the motor or utility vehicle. For example, the surface of a tipper body can be equipped with the motor and utility vehicle supporting device in order to provide minimum sliding friction between the goods and the tipper body.

Moreover, the motor and utility vehicle supporting device may contribute to noise insulation. This is made possible in particular by the cover coating made of polyurethane, polyurea and/or epoxy resin. If for example an access ramp is equipped with the motor and utility vehicle supporting device, noise pollution during loading and clearing the motor or utility vehicle can be prevented or reduced. Apart from that, the motor and utility vehicle supporting device can also be used for thermal insulation purposes.

In a preferred embodiment, the lightweight board comprises plastics, lightweight metals such as aluminium and/or fibre-reinforced composites or a combination thereof. The lightweight board offers the strength required for the application at a relatively low weight. This has the advantage that the motor and utility vehicle supporting device is easy to process further or install. The low weight of the motor and utility supporting device furthermore positively impacts the total weight of the motor or utility vehicle.

In the case of fibre-reinforced composites, reinforcing fibres can be embedded in a polymer matrix. Carbon fibres, glass fibres, plastic fibres, natural fibres and/or metal fibres can be used as reinforcing fibres.

In addition to providing good strength at comparatively low weight, the use of aluminium allows also for providing the function of an infra-red reflecting coating at the same time.

In a further embodiment, a second cover coating is arranged on the first cover coating. This allows for the integration of yet another functional layer into the floor, wall and ceiling cladding. In the alternative, the second cover coating can be arranged between the first surface of the support plate and the first cover coating, between the second surface and the adhesive layer or on the side of the adhesive layer facing away from the support plate.

In a preferred embodiment, the lightweight board comprises a polymer encased between two aluminium layers. Compared to conventional motor and utility vehicle supporting devices, such a lightweight board is characterised by comparatively small thickness relative to its high strength and rigidity. For example, compared to a coated screen printing panel, the thickness of a lightweight board consisting of a polymer embedded in aluminium can be reduced by 75%. In addition, this type of motor and utility vehicle supporting device provides for comparatively good thermal insulation properties.

In a further development, the lightweight board comprises a polymer encased between two aluminium layers. By providing the polymer layer in the form of a foam layer, the weight of the motor and utility supporting device can be reduced even further. In addition to its low weight, such a layer is characterised by its small thickness whilst providing and sufficient strength. Sufficient strength means that strength provided is sufficient for the usual use cases for motor and utility supporting devices. Furthermore, such a lightweight board is suitable for being adjusted to the surrounding geometry. For example, the motor and utility supporting device is also suitable for assembly across corners. Overall, this type of lightweight board provides good malleability during assembly and makes do with a comparatively small weight and layer thickness.

All in all, such a lightweight board complements the properties of a sandwich design. The lightweight board comprising a polymer foam that is encased between two aluminium layers is characterised by comparatively high shear strength, high load-bearing capacity and a generally high degree of rigidity. Furthermore, the polymer foam has comparatively good thermal insulating properties.

In a further preferred embodiment the polymer foam is a polypropylene foam or a polyethylene foam. Due to the low density of the polypropylene foam, it is possible to provide a comparatively light lightweight board. In addition, polypropylene is characterised by high fatigue resilience. This is particularly advantageous in case the motor and utility supporting device is subject to frequent application of force, for example in the case of an access ramp.

In another preferred embodiment, the strength properties of the lightweight board are greater than the strength properties of the cover coating. Thus gaps can be bridged in case surfaces are uneven. Thus, the properties of the functional cover layer can be utilised across the entire surface of the cover layer.

This relative strength distribution between the lightweight board and the cover coating allows for enhanced pressure distribution when forces are applied locally to the motor and utility supporting device.

In a further preferred embodiment, the space weight ratio of the support layer to the cover coating and the adhesive fastening is in a range of 2 to 5.

In another preferred embodiment, the cover coating has an anti-slip coefficient of at least R10. An anti-slip coefficient of R10 according to DIN 51130 renders anti-slip mats obsolete. Moreover, the load can be secured with relatively fewer lashing straps. All in all, the loading and clearing times can be reduced and risk of injury for the employees can be minimised. Overall costs can be reduced.

In another preferred embodiment, the cover coating has a slide-friction coefficient of at least 0.6 μD. This slide-friction coefficient is certified according to VDI Guideline 2700/Sheet 14. The slide-friction coefficients are the basis for the extent of the load securing requirements pursuant to DIN-EN 12195-1 (June 2011). Accordingly, the motor and utility vehicle supporting device allows for exceptionally good load securing properties both under wet and dry conditions.

In a preferred embodiment, the cover coating has a smooth, rough or textured outer surface. The cover coating can be adapted to the respective use case. If sliding properties of the motor and utility supporting device are required, the cover coating can be configured as a smooth cover coating to exhibit small slide-friction coefficients. If, however, the specific use case requires anti-slip properties, the cover coating can be configured as a rough or structured cover coating.

In another preferred embodiment, the cover coating has an elongation at break of at least 150%. Thus, high temperature differences can be compensated without tears forming in the cover coating.

In another preferred embodiment, the adhesive fastening comprises a backing-based adhesive tape, a transfer adhesive tape or a liquid adhesive.

A backing-based adhesive tape, in particular a double-sided backing-based adhesive tape, has the ability to control for example its elastic properties via the backing material and the latter's properties (foam, paper, film). In addition, by being able to choose the type of adhesive used on either side of the backing material, the adhesive properties with respect to different surfaces can be matched to the particular characteristics of the surfaces to be glued together.

Similar characteristics are true for transfer adhesive tape without backing where, for example, also two different types of adhesive can be coated directly on top of each other, thus catering for different surfaces to be glued together. As a rule, however, the adhesive fastening is homogeneous and consists in just one material. As far as resilience is concerned, transfer adhesive tape is substantially inferior to double-sided adhesive tape with a foam backing, but the former is usually more cost-effective, because no backing material is required.

Liquid adhesives are used for structural bonding, i.e. they are applied directly to one or both of the elements to be joined at the site of use, and then these two elements are brought into contact and glued together, for example under pressure or thermal impact.

Apart from that, today adhesive tape for structural bonding exists, too. The term structural here means that the connection exhibits a uniform structure after the gluing step. Any disruption of the connection no longer necessarily occurs at the gluing point but anywhere in the system, for example in one of the elements to be glued together. As a rule, the bonding is effected through pressure, thermal impact and/or humidity, allowing the adhesive to cure, so that the adhesive bond can be achieved.

Such connections, just like liquid bonds, are significantly stronger and more durable and can withstand more strain, but at the same time, they cannot be separated again without damaging the elements that were glued together. Generally, they require more time and resources for storage and processing. For example, storage at low temperatures may be required to prevent premature curing.

In another preferred embodiment, the backing-based adhesive tape comprises a soft-elastic backing, preferably a foam backing. Consequently, the adhesive fastening can also act as a levelling layer for uneven surfaces. In addition, the soft-elastic backing of the adhesive fastening increases the sound-insulating properties of the motor and utility supporting device.

In another preferred embodiment, the adhesive fastening comprises acrylates, polyurethane, epoxies, silicone and/or natural rubber.

In a further preferred embodiment, a tear-off film is arranged on the outer surface of the adhesive fastening. The tear-off film, also known as release liner, allows for easy storage. This way, the motor and utility supporting device can be also be stacked. Apart from that, due to the tear-off film, the motor and utility supporting device is ready for processing. After removing the tear-off film, motor and utility supporting device can be applied directly to the site of use.

In a further embodiment, an additional fastening means is integrated into the layer structure of the cover coating, the support layer, and the adhesive fastening, for fastening the motor and utility supporting device to a backboard of a motor or utility vehicle. Thus part of the forces exerted on the motor and utility supporting device can be absorbed and the load bearing on the adhesive fastening is reduced. Moreover it can be ensured that in the event that the adhesive fastening fails for example due to age, weather effects or chemical influences, which may for example be caused by leakage of chemical goods, the motor and utility supporting device is retained safely on the backboard of the motor or utility vehicle.

The fastening means can be formed as screws, nails, suction plugs or Velcro. In addition, the fastening means can also be formed as a permanent magnet integrated in the support layer.

In a further embodiment of the invention, the cover coating is made of a flame-retardant material. This may for example comprise 20 to 80% by weight of a polycarbonate composition, 1 to 20% by weight of a laser-activated additive and 1 to 20% by weight of a phosphazene compound. This gives the motor and utility vehicle supporting device additional flame retardant properties.

In a preferred embodiment, at least one transponder is integrated in the support layer or the cover coating, preferably an RFID transponder. This allows the floor, motor and utility vehicle supporting device to interact with the environment. Depending on the type of transponder used, it is possible for example to identify moving objects located on the motor and utility vehicle supporting device.

The object specified above is also achieved by a method utilising the features of claim 18. Accordingly, a method is suggested for the production of a motor and utility vehicle supporting device, comprising the following steps: Providing the support layer, applying the adhesive fastening on the second surface of the support layer, and coating the first surface of the support layer with the cover coating using a spraying or casting method. By applying the cover coating using a spraying or casting method, the properties of the cover coating can be modified relatively quickly and easily during production. Thus, layer thicknesses can be varied or additives can be included as desired.

In a further preferred embodiment, solid particles such as hard grain are sprayed or cast when the support layer is coated with the cover coating. Hence, no additional processing step is necessary for example in order to create a rough surface of the cover coating.

### BRIEF DESCRIPTION OF THE FIGURES

More preferred embodiments of the invention are illustrated in further detail by the subsequent description of the Figures. In this:

FIG. 1 shows a schematic sectional view of the layer configuration of a motor and utility supporting device,

FIG. 2 shows a schematic sectional view of the motor and utility vehicle supporting device of FIG. 1 with a tear-off film,

FIG. 3 shows a schematic sectional view of a motor and utility vehicle supporting device, comprising a lightweight board consisting in a polymer foam encased between two aluminium layers,

FIG. 4 shows a schematic sectional view of the motor and utility supporting device of FIG. 3 where it is applied to an uneven surface,

FIG. 5 shows a schematic sectional view of the motor and utility vehicle supporting device with a backing-based adhesive tape,

FIG. 6 shows a schematic sectional view of the motor and utility vehicle supporting device of FIG. 5 on an uneven surface,

FIG. 7 shows a schematic sectional view of the motor and utility vehicle supporting device with three adhesive layers,

FIG. 8 shows a schematic sectional view of the motor and utility vehicle supporting device with adhesive layers adapted to the support layer, and

FIG. 9 shows a schematic sectional view of the motor and utility supporting device with an adhesive layer comprising two backings.

### DETAILED DESCRIPTION OF PREFERRED EMBODIMENTS

Preferred embodiments based on the Figures are described hereinafter. In this, identical or similar elements or elements with the same effect are referenced with identical reference numerals. So as to avoid redundancies, these elements are not repeatedly described in the description following hereinafter.

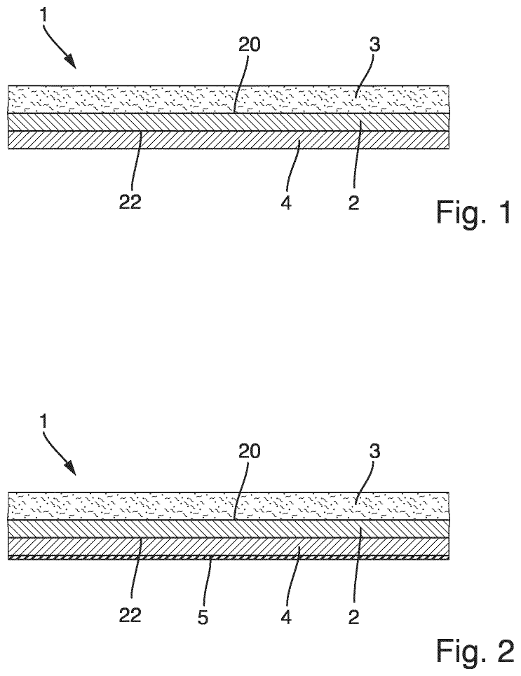

FIG. 1 shows a sectional view of a motor and utility vehicle supporting device 1. The motor and utility vehicle supporting device 1 consists in a layered configuration, including a support layer 2 in the form of a lightweight board. In the case in hand, the lightweight board is made of aluminium. Alternatively, the lightweight board can also be made of other materials such as for example plastics. As far as plastics are concerned, for example, lightweight boards made of fibre-reinforced composites can be used. For example in the form of reinforcing embedded in a polymer matrix. Carbon fibres, glass fibres, plastic fibres, natural fibres or metal fibres can be used as reinforcing fibres.

The support layer 2 has a first surface 20 and a second surface 22. The first surface 20 is coated with a cover coating 3. The cover coating 3 can be made of epoxy resin, polyurethane or polyurea, which originally are sprayed on the first surface 20 of the support layer 2 in the form of a resin curing agent mixture. For the embodiment in hand, the solvent-free two-component reactive spray coating VIASEAL LCT1616-60 by the company VIACOR Polymer GmbH is used. It has excellent resilient properties and serves as an anti-slip coating. The cured product has a tensile strength of at least 11 N/mm² (DIN 53504), elongation at break of at least 300% (DIN 53504) and a shore-A hardness of ca. 88 (5 d/23° C.) (DIN EN ISO 868). Moreover, when spraying the cover coating 3 onto the first surface 20 hard grain can be included so as to increase roughness of an outer surface of the cover coating 3. In the latter case, alternatively, also the solvent-free two-component reactive spray VIASEAL LCT1622-60 by the company VIACOR Polymer GmbH can be used as cover coating. It is comparatively harder and is thus well-suited for incorporating granulate such as hard grain.

The combination consisting in the support layer 2 and the cover coating 3 is resistant to high mechanical loads and large temperature differences. Moreover, the bond between the support layer 2 and the cover coating 3 withstands strong deformations, too.

An adhesive fastening 4 is arranged on the second surface 22 of the support layer 2 in the form of a backing-based adhesive tape, whereas the backing comprises a soft foam. Thus, due to the resilience properties of the adhesive fastening, irregularities in the surface elements are to be affixed to can be levelled out. By way of the adhesive fastening 4, the motor and utility vehicle supporting device can be glued to the respective site of use. In the alternative, the adhesive fastening can also comprise a transfer adhesive tape, i.e. a tape without a backing.

The combination of the cover coating 3, the support layer 2 and the adhesive layer 4 allows for providing a motor and utility vehicle supporting device that exhibits a functional surface that is capable of advantageously distributing forces impacting the device and that can be installed in a straightforward fashion at the site of use. Hence, the composition of the cover coating 3 can be selected such that for example anti-slip or slide-enhancing properties can be provided. The support layer 2 in the form of an aluminium lightweight board gives the motor and utility vehicle supporting device sufficient hardness and stiffness properties whilst keeping its weight relatively low. By way of the adhesive fastening 4, the motor and utility vehicle supporting device can be fastened to various walls or backboards of motor and utility vehicles. By way of example: tail lifts, side lifts, access ramps, etc.

FIG. 2 shows the motor and utility vehicle supporting device from FIG. 1, additionally including a tear-off film 5 on the outer surface of the adhesive fastening 4. The tear-off film 5 can remain on the adhesive fastening 4 just up until the motor and utility vehicle supporting device is installed. In particular, transport and storage of the motor and utility vehicle supporting device can be facilitated.

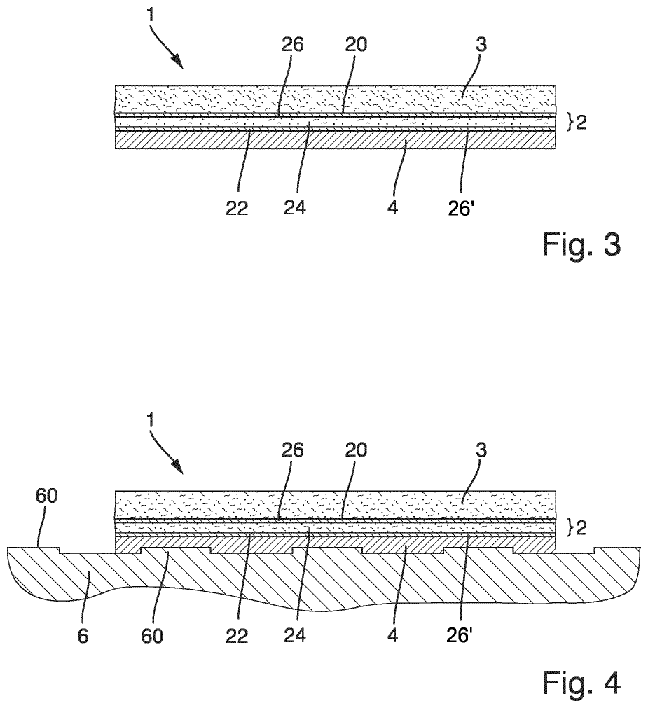

FIG. 3 shows a schematic sectional view of a layer construction of a motor and utility vehicle supporting device 1 including a support layer 2 in the form of a lightweight board comprising a polymer foam 24 encased between two aluminium layers. The polymer foam 24 is made of polypropylene, which is characterised by particularly low density. A support layer 2, consisting in two aluminium layer 26, 26′ and a polypropylene polymer foam layer encased in between these two layers is characterised by high strength and comparatively low weight.

Moreover, the polymer foam 24 comes with the advantage that it is malleable. For example, the motor and utility supporting device is also suitable for assembly across corners. Moreover, the polymer foam 24 encased between the aluminium layers 26, 26′ is characterised by good thermal insulation properties. The adhesive fastening 4 shown in FIG. 3 is formed by a transfer adhesive tape and is glued to the side of the aluminium layer 26′ facing away from the polymer foam 24.

FIG. 4 shows the motor and utility vehicle supporting device 1 from FIG. 3, whereas the adhesive fastening 4 compensates for unevenness of the surface 6 of the motor or utility vehicle. Such an uneven surface 6 may for example also be caused by groves on an access ramp. The adhesive fastening 4 is a transfer adhesive tape. In FIG. 4, unevenness is shown as protrusions 60. The adhesive fastening 4 thus allows for almost constant performance of the motor and utility vehicle supporting device, regardless of the surface of the motor or utility vehicle.

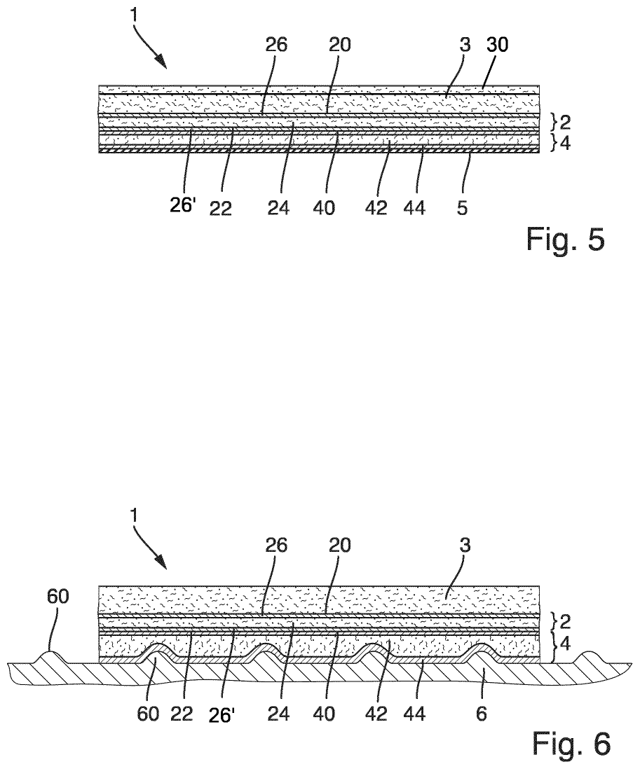

FIG. 5 shows a motor and utility vehicle supporting device 1 similar to the motor and utility vehicle supporting device of FIG. 3. In contrast to the transfer adhesive tape shown in FIG. 3, the motor and utility vehicle supporting device 1 shown in FIG. 5 includes an adhesive layer 4 in the form of a backing-based adhesive tape. The backing-based adhesive tape forms a double-sided adhesive tape, comprising a first adhesive layer 40, a backing 42 and a second adhesive layer 44. The backing 42 is arranged between the first adhesive layer 40 and the second adhesive layer 44. The first adhesive layer 40 abuts the aluminium layer 26′ of the support layer 2. A tear-off film 5 is arranged on the bottom surface of the second adhesive layer 44.

Moreover, the motor and utility vehicle supporting device 1 shown in FIG. 5 includes a second cover coating 30 on the first cover coating 3. The second cover coating may for example provide an additional function and apart from polyurethane, polyurea and/or epoxy resin may for example include further functional materials. For example, the second layer may include soot particles or electrically conductive fibres in order to give the surface of the motor and utility vehicle supporting device 1 increased electric conductivity.

FIG. 6 shows the motor and utility vehicle supporting device 1 from FIG. 5, whereas the adhesive fastening 4 compensates for unevenness of the surface 6 of a motor or utility vehicle. The motor and utility vehicle supporting device 1 is glued to the surface 6 and therefore no longer includes the tear-off film.

The protrusions 60 protruding from the surface 6 are compensated for by the adhesive fastening 4. The second adhesive layer 44 follows the profile of the surface 6. The thickness of the second adhesive layer 44 remains almost constant. The backing 42, in turn, is compressed in the areas of the protrusions 60. Thus, it is possible to install the motor and utility vehicle supporting device 1 also on uneven, for example serrated surfaces without the adhesive bond between the motor and utility vehicle supporting device 1 and the surface 6 being compromised.

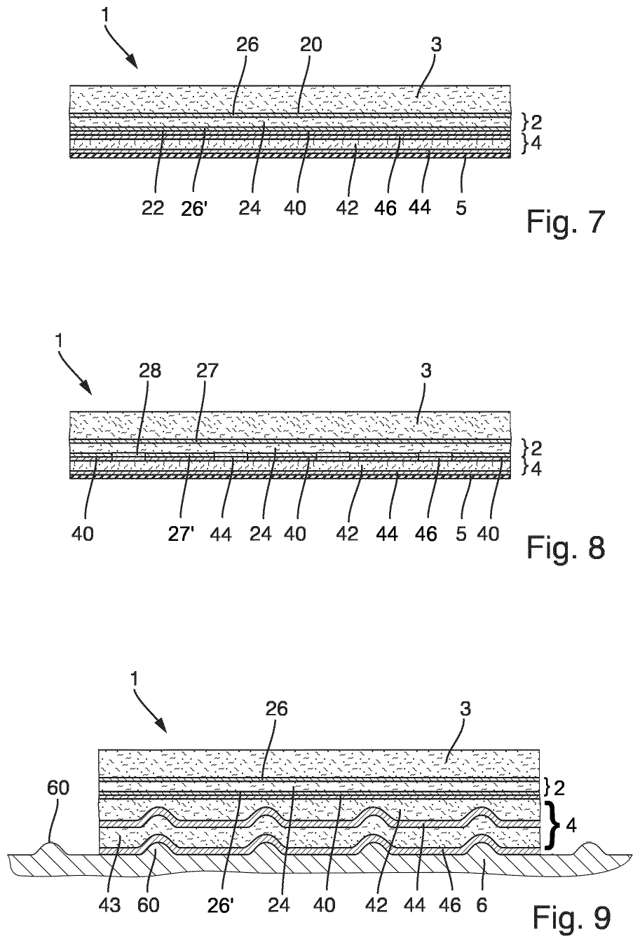

FIG. 7 shows a motor and utility vehicle supporting device 1 similar to the motor and utility vehicle supporting device of FIG. 5. The adhesive fastening 4 deviates from the adhesive layer shown in FIG. 5 in that it comprises an additional adhesive layer between the support layer 2 and the backing 42. In particular, a first adhesive layer 40 is adapted to the requirements associated with creating an adhesive bond with the aluminium layer 26 and an adjacent third adhesive layer 46 is adapted to the requirements associated with creating an adhesive bond with the backing 42. By selecting the corresponding first and third adhesive layers 40, 46 depending on the materials of the support layer 2 and the backing 42, high-grade adhesion can be achieved, i.e. optimal cohesion of the compound can be ensured. A second adhesive layer 44 is applied on the bottom surface of the backing 42. In its non-assembled state, the bottom side of the adhesive fastening is sealed with a tear-off film 5.

FIG. 8 shows a motor and utility vehicle supporting device 1 according to FIG. 5 with the only difference that the bottom surface of the support layer 2 exhibits different materials. One glass fibre layer 27′ is arranged alternating with a carbon fibre layer 28. Moreover, the adhesive fastening 4 is adapted to the different material pairing of the support layer 2 so that a first adhesive layer 40 contacts the glass fibre layer 27′ and a third adhesive layer 46 contacts the carbon fibre layer 28. By selecting the corresponding first and third adhesive layers 40, 46 depending on the materials of the support layer 2 and the backing 42, high-grade adhesion can be achieved, i.e. optimal cohesion of the compound can be ensured. A second adhesive layer 44 is applied on the bottom surface of the backing 42. In its non-assembled state, the bottom side of the adhesive fastening 4 is sealed with a tear-off film 5.

FIG. 9 shows a motor and utility vehicle supporting device 1 according to FIG. 6 with the only difference that the adhesive fastening 4 comprises another backing 43 and a third adhesive layer 46. The adhesive fastening 4 has the following layer sequence: first adhesive layer 40, backing 42, second adhesive layer 44, backing 43 and third adhesive layer. The protrusions 60 protruding from the surface 6 are compensated for by the adhesive fastening 4. The second and third adhesive layers 44,46 follow the profile of the surface 6. The thickness of the second and third adhesive layers 44 remains almost constant. The backings 42, 43 in turn, is compressed in the areas of the protrusions 60.

As far as applicable, all individual features shown in the individual embodiments can be combined and/or exchanged without leaving the scope of the invention.

### LIST OF REFERENCE NUMERALS

1 Motor and utility vehicle supporting device

2 Support layer

20 First surface

22 Second surface

24 Polymer foam

26, 26′ Aluminium layer

27, 27′ Glass fibre layer

28 Carbon fibre layer

3 Cover coating

30 Second cover coating

4 Adhesive fastening

40 First adhesive layer

42 Backing

43 Backing

44 Second cover coating

46 Third cover coating

5 Tear off film

6 Surface

60 Protrusion

1. A motor and utility vehicle supporting device for a tail lift, a side wall, an access ramp, and/or the bed of a motor and utility vehicle, comprising: a support layer having a first surface and a second surface, wherein the support layer comprises a lightweight board, a top coating placed on the first surface, said top coating comprising polyurethane, polyurea and/or epoxy resin, and an adhesive fixing element which is arranged on the second surface.

2. The motor and utility vehicle supporting device of claim 1, wherein the lightweight board comprises a material selected from the group of plastics, lightweight metals, fibre-reinforced composites, and any combination thereof.

3. The floor, wall and ceiling cladding of claim 1, wherein a second cover coating is arranged on the first cover coating.

4. The motor and utility vehicle supporting device of claim 1, wherein the lightweight board comprises a polymer encased between two aluminum layers.

5. The motor and utility vehicle supporting device of claim 1, wherein the lightweight board comprises a polymer foam encased between two aluminium layers.

6. The motor and utility vehicle supporting device of claim 5, wherein the polymer foam is a polypropylene foam or a polyethylene foam.

7. The motor and utility vehicle supporting device of claim 1, wherein the strength properties of the lightweight board are higher than the strength properties of the cover coating.

8. The motor and utility vehicle supporting device of claim 1, wherein the space weight ratio of the support layer to the cover coating and the adhesive fastening is in a range of 2 to 5.

9. The motor and utility vehicle supporting device of claim 1, wherein that the cover coating has an anti-slip coefficient of at least R10.

10. The motor and utility vehicle supporting device of claim 1, wherein the cover coating has a slide-friction coefficient of at least 0.6 μD.

11. The motor and utility vehicle supporting device of claim 1, wherein that the cover coating has an outer surface that is smooth, rough or structured.

12. The motor and utility vehicle supporting device of claim 1, wherein the cover coating has an elongation at break of at least 150%.

13. The motor and utility vehicle supporting device of claim 1, wherein the adhesive fastening comprises a backing-based adhesive tape, a transfer adhesive tape or a liquid adhesive.

14. The motor and utility vehicle supporting device according to claim 13, wherein the backing-based adhesive tape comprises a soft elastic backing, preferably a foam backing.

15. The motor and utility vehicle supporting device of claim 1, wherein the adhesive fastening comprises acrylate, polyurethane, epoxies, silicone and/or natural rubber.

16. The motor and utility vehicle supporting device of claim 1, wherein a tear-off film is arranged on one outer surface of the adhesive fastening.

17. The motor and utility vehicle supporting device of claim 1, wherein an additional fastening means is integrated in the layer design of the cover coating, the support layer and the adhesive fastening for fastening the motor and utility vehicle supporting device on a surface of a motor or utility vehicle.

18. A method for manufacturing a motor and utility vehicle supporting device of claim 1, comprising:
providing the support layer, applying the adhesive fastening 4 on the second surface of the support layer, and
coating the first surface of the support layer with the cover coating using a spraying or casting method.

19. The method for producing a motor and utility vehicle supporting device of claim 18, wherein when coating the support layer with the cover coating, solid bodies such as hard grain are sprayed or cast together with the coating.

20. The method for manufacturing a motor and utility vehicle supporting device of claim 18, wherein a final spray coating step the spray coat is applied from a distance calculated such that a sprayed-on plastic starts reacting before it reaches the cover coating or a second cover coating, thus producing an uneven surface on the cover coating.
